(19) United States
(12) Patent Application Publication
(10) Pub. No.: US 2010/0238768 A1
(43) Pub. Date: Sep. 23, 2010

(54) Stepping motor control circuit and analogue electronic timepiece

(76) Inventors: Kazuo Kato, Chiba-shi (JP); Keishi Honmura, Chiba-shi (JP); Saburo Manaka, Chiba-shi (JP); Kenji Ogasawara, Chiba-shi (JP); Kazumi Sakumoto, Chiba-shi (JP); Takanori Hasegawa, Chiba-shi (JP); Kosuke Yamamoto, Chiba-shi (JP); Akira Takakura, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/661,381

(22) Filed: Mar. 16, 2010

(30) Foreign Application Priority Data
Mar. 18, 2009 (JP) 2009-065973
Jan. 8, 2010 (JP) 2010-003351

(51) Int. Cl. G04B 19/04; H02P 8/38

(52) U.S. Cl. 368/80; 318/696

(57) ABSTRACT

A stepping motor control circuit and an analogue electronic timepiece can optimize a rank change operation of a main drive pulse by properly determining an available driving force thus realizing the reduction of the power consumption. A detection interval in which a rotation state of a stepping motor is detected is divided into a first interval immediately after driving with a main drive pulse, a second interval which comes after the first interval, and a third interval which comes after the second interval, and a rotation state is detected. A control circuit looks up an interval table which makes respective main drive pulses stored in the control circuit and a length of the second interval, sets the second interval which corresponds to energy of the present main drive pulse. A detection interval determination circuit determines the interval or the intervals in which an induction signal which exceeds a reference threshold voltage is generated. The control circuit performs a pulse control of the main drive pulse based on the determination.

### BACKGROUND OF THE INVENTION

1. Field of the Invention

The present invention relates to a stepping motor control circuit, and an analogue electronic timepiece which uses the stepping motor control circuit.

2. Related Art

Conventionally, a stepping motor having the following constitution has been used in an analogue electronic timepiece or the like. The stepping motor includes a stator which has a rotor accommodating hole and a positioning part for positioning a stop position of a rotor, the rotor which is arranged in the rotor accommodating hole, and a coil, wherein an alternating signal is supplied to the coil so that a magnetic flux is generated in the stator thus rotating the rotor, and the rotor is stopped at a position corresponding to the positioning part.

Conventionally, as a control method of above-mentioned stepping motor, a following correction drive method has been adopted (see JP-B-61-15385 (patent document 1), for example). In driving a stepping motor with a main drive pulse P1, whether the rotor is rotated or not is detected by detecting an induction signal generated in the stepping motor, and the stepping motor is driven by changing the main drive pulse P1 to a pulse having a different pulse width or by forcibly rotating the stepping motor with a correction drive pulse P2 having a larger pulse width than the main drive pulse P1 corresponding to the result of detection of whether or not the rotor is rotated.

Further, WO2005/119377 (patent document 2) discloses a following control method of above-mentioned stepping motor. In detecting the rotation of a stepping motor, in addition to the detection of an induction signal, a unit which performs a comparison and discrimination of a detection time and a reference time is provided. When a detection signal becomes lower than a predetermined reference threshold voltage Vcomp after rotatably driving the stepping motor with a main drive pulse P11, a correction drive pulse P2 is outputted, and the stepping motor is driven by changing a next main drive pulse P1 to a main drive pulse P12 having larger energy than the previous main drive pulse P11 (pulse up). When the detection time at which the stepping motor is driven with the main drive pulse P12 comes earlier than the reference time, the drive pulse is changed to the main drive pulse P11 from the main drive pulse P12 (pulse down). Accordingly, the control method disclosed in patent document 2 can detect a load state more accurately than the control method disclosed in patent document 1 and hence, the stepping motor can be rotated with the main drive pulse P1 corresponding to a load and hence, the current consumption can be decreased.

However, although an induction voltage induced during a detection period usually has a tendency that a generation time of an induction signal is delayed when the degree of available driving is reduced, there exists a possibility that an available driving force cannot be properly determined due to a variation in time at which an induction signal is generated caused by variation in load change, variation in characteristics at the time of mass production or the like.

### SUMMARY OF THE INVENTION

It is an aspect of the present invention to provide a stepping motor control circuit and an analogue electronic timepiece which can optimize a rank change operation of a main drive pulse by properly determining an available driving force thus realizing the reduction of the power consumption.

According to the present invention, there is provided a stepping motor control circuit including: a rotation detection unit which detects an induction signal which is generated in response to rotation of a rotor of a stepping motor, and detects a rotation state of the stepping motor based on whether or not the induction signal exceeds a predetermined reference threshold voltage within a predetermined detection interval; and a control unit which performs a drive control of the stepping motor with any one of a plurality of main drive pulses which differ in energy from each other or a correction drive pulse having larger energy than the respective main drive pulses corresponding to a detection result of the rotation detection unit, wherein the detection interval is divided into a first interval immediately after driving with the main drive pulse, a second interval which comes after the first interval, and a third interval which comes after the second interval, and in a usual load state, the first interval is an interval in which a normal-direction rotation state of the rotor is determined and an interval in which a first reverse-directional rotation state of the rotor is determined in a third quadrant of a space about the rotor, the second interval is an interval in which the first reverse-directional rotation state of the rotor is determined in the third quadrant, and the third interval is an interval in which a rotation state of the rotor after the first reverse-directional rotation is determined in the third quadrant, and the control unit sets the second interval such that the smaller the energy of the main drive pulse, the longer the second interval becomes, and the control unit determines the rotation state.

Further, according to the present invention, there is provided a stepping motor control circuit in which the control unit sets the start timing of the third interval such that the smaller the energy of the main drive pulse, the more the start timing of the third interval is delayed, and the control unit determines the rotation state.

According to the present invention, there is provided a stepping motor control circuit including: a rotation detection unit which detects an induction signal which is generated in response to rotation of a rotor of a stepping motor, and detects a rotation state of the stepping motor based on whether or not the induction signal exceeds a predetermined reference threshold voltage in a predetermined detection interval; and a control unit which performs a drive control of the stepping motor with any one of a plurality of main drive pulses which differ in energy from each other or a correction drive pulse having larger energy than the respective main drive pulses corresponding to a detection result of the rotation detection unit, wherein the detection interval is divided into a plurality of intervals, and the control unit performs a control of changing start timing of the interval corresponding to an amount of drive energy of the stepping motor.

Further, according to the present invention, there is provided an analogue electronic timepiece which includes: a stepping motor which rotationally drives hands; and a stepping motor control circuit which controls the stepping motor, wherein the stepping motor control circuit described in any one of the above-mentioned constitutions is used as the stepping motor control circuit.

According to the motor control circuit and the analogue electronic timepiece, by properly determining degree of available driving force, a rank change operation of the main drive pulse can be optimized so that the power consumption can be realized. Further, by optimizing degree of available rank-up driving, it is possible to realize the reduction of the power consumption.

### BRIEF DESCRIPTION OF THE DRAWINGS

FIG. 1 is a block diagram of a stepping motor control circuit and an analogue electronic timepiece according to an embodiment of the present invention;

FIG. 2 is a constitutional view of a stepping motor used in the analogue electronic timepiece according to the embodiment of the present invention;

FIG. 3 is a timing chart for explaining the manner of operation of the stepping motor control circuit and the analogue electronic timepiece according to the embodiment of the present invention;

FIGS. 4A to 4D show timing charts for explaining the manner of operation of the stepping motor control circuit and the analogue electronic timepiece according to the embodiment of the present invention;

FIG. 5 is a flowchart showing processing of the stepping motor control circuit and the analogue electronic timepiece according to the embodiment of the present invention;

FIG. 6 is a determination chart for explaining the manner of operation of the stepping motor control circuit and the analogue electronic timepiece according to the embodiment of the present invention;

FIGS. 7A to 7D show timing charts for explaining the manner of operation of a stepping motor control circuit and an analogue electronic timepiece according to another embodiment of the present invention;

FIG. 8 is a flowchart showing processing of the stepping motor control circuit and the analogue electronic timepiece according to another embodiment of the present invention;

FIG. 9 is a block diagram of a stepping motor control circuit and an analogue electronic timepiece according to still another embodiment of the present invention;

FIG. 10A to 10D show timing charts for explaining the manner of operation of a stepping motor control circuit and an analogue electronic timepiece according to still another embodiment of the present invention; and

FIG. 11 is a flowchart showing processing of a stepping motor control circuit and an analogue electronic timepiece according to still another embodiment of the present invention.

### DESCRIPTION OF THE PREFERRED EMBODIMENT

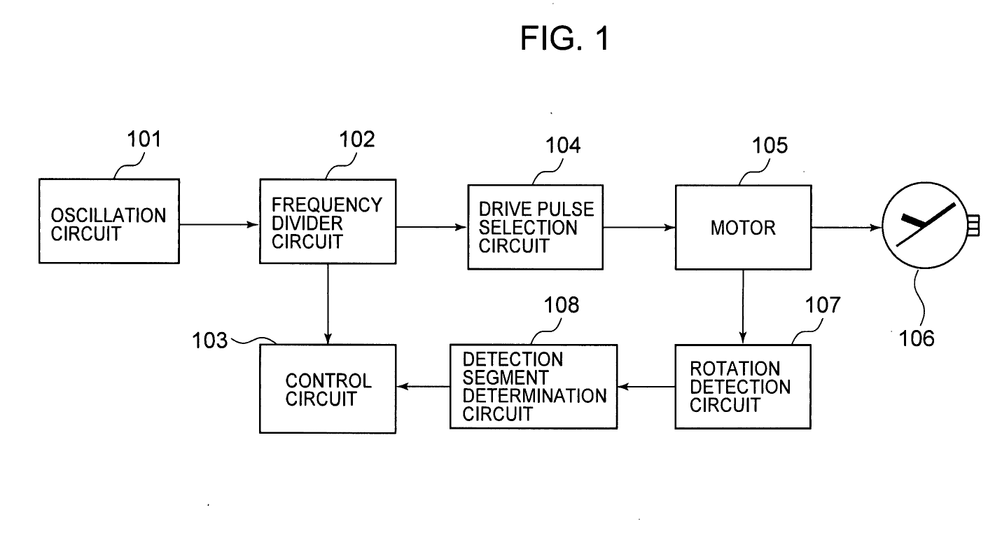

FIG. 1 is a block diagram of an analogue electronic timepiece which uses a motor control circuit according to an embodiment of the present invention, wherein an analogue electronic watch is shown as an example.

In FIG. 1, the analogue electronic timepiece includes an oscillation circuit 101 which generates a signal of predetermined frequency, a frequency dividing circuit 102 which generates a timepiece signal which becomes the reference in counting times by dividing the frequency of the signal generated by the oscillation circuit 101, a control circuit 103 which performs controls such as a control of respective electronic circuit elements which constitute an electronic timepiece and a control of changing a drive pulse, a drive pulse selection circuit 104 which selects and outputs a drive pulse for rotational driving of a motor based on a control signal from the control circuit 103, a stepping motor 105 which is rotatably driven with a drive pulse from the drive pulse selection circuit 104, and an analogue display part 106 having hands which are rotatably driven by the stepping motor 105 for displaying time.

Further, the analogue electronic timepiece includes a rotation detection circuit 107 which detects an induction signal indicative of a rotation state of the stepping motor 105 during a predetermined detection interval, and a detection interval determination circuit 108 which, by comparing a point of time that an induction signal VRs which exceeds a predetermined reference threshold voltage Vcomp is detected with an interval during which the induction signal VRs is detected, determines the interval during which the induction signal VRs is detected. As described later, the detection interval during which the detection whether or not the stepping motor 105 is rotated is made is divided into three intervals.

The rotation detection circuit 107 is configured to detect an induction signal using the substantially same principle used by the rotation detection circuit disclosed in the above-mentioned patent document 1, and detects an induction signal VRs which exceeds a predetermined reference threshold voltage Vcomp.

Here, the oscillation circuit 101 and the frequency dividing circuit 102 constitute a signal generation unit, and the analogue display part 106 constitutes a time display unit. The rotation detection circuit 107 constitutes a rotation detection unit, and the control circuit 103, the drive pulse selection circuit 104 and a detection interval determination circuit 108 constitute a control unit.

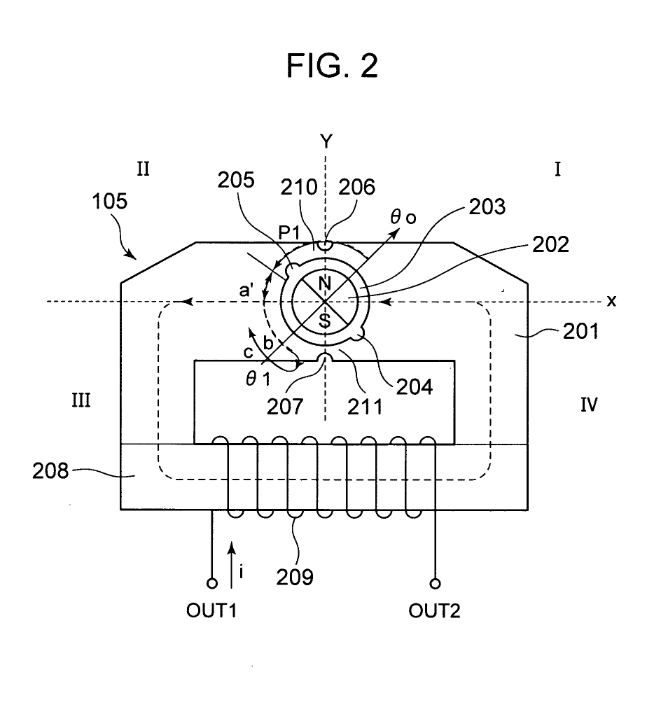

FIG. 2 is a constitutional view of the stepping motor 105 used in the embodiment of the present invention, and shows a timepiece-use stepping motor used in general as an analogue electronic timepiece as an example.

In FIG. 2, the stepping motor 105 includes a stator 201 having a rotor accommodating through hole 203, a rotor 202 which is rotatably arranged in the rotor accommodating through hole 203, a magnetic core 208 which is joined to the stator 201, and a coil 209 wound around the magnetic core 208. In using the stepping motor 105 in an analogue electronic timepiece, the stator 201 and the magnetic core 208 are fixed to a ground plate (not shown in the drawing) and are joined to each other by bolts (not shown in the drawing). The coil 201 includes a first terminal OUT1 and a second terminal OUT2.

The rotor 202 is magnetized to two poles (S pole and N pole). On an outer end portion of the stator 201 formed using a magnetic material, a plurality of (two in this embodiment) notched portions (outer notches) 206, 207 are formed at positions which face each other in an opposed manner with the rotor accommodating through hole 203 sandwiched therebetween. Saturable portions 210, 211 are provided between the respective outer notches 206, 207 and the rotor accommodating through hole 203.

The saturable portions 210, 211 are not magnetically saturated with a magnetic flux of the rotor 202, and is magnetically saturated when the coil 209 is excited so as to increase the magnetic resistance. The rotor accommodating through hole 203 is formed into a circular hole shape where a plurality of (two in this embodiment) semicircular notched portions (inner notches) 204, 205 are integrally formed with a through hole having a circular profile at opposed positions.

The notched portions 204, 205 constitute positioning portions for determining stop positions of the rotor 202. In a state where the coil 209 is not excited, as shown in FIG. 2, the rotor 202 is stably stopped at a position corresponding to a positioning portion. In other words, the rotor 202 is stably stopped at a position where a magnetic pole axis A of the rotor 202 becomes orthogonal to a line segment which connects the notched portions 204, 205 (at a position of angle θ0). An XY coordinate space about a rotational axis (center of rotation) of the rotor 202 is divided into four quadrants (first quadrant I to fourth quadrant IV).

When a drive pulse having a rectangular waveform is supplied between the terminals OUT1, OUT2 of the coil 209 from the drive pulse selection circuit 104 (for example, setting a first terminal OUT1 side as a positive pole, and a second terminal OUT2 side as a negative pole) thus allowing an electric current i to flow in the direction indicated by an arrow shown in FIG. 2, a magnetic flux is generated in the stator 201 in the direction indicated by a broken-line arrow. Accordingly, the saturable portions 210, 211 are saturated so that the magnetic resistance is increased. Thereafter, due to an interaction between a magnetic pole generated in the stator 201 and a magnetic pole of the rotor 202, the rotor 202 is rotated in the direction indicated by an arrow in FIG. 2 by 180 degrees, and is stably stopped at a position where the magnetic pole axis assumes an angle θ1. Here, assume the rotational direction (counterclockwise direction in FIG. 2) along which a normal operation (hand moving operation in this embodiment, because of the use of the analogue electronic timepiece) is performed by rotatably driving the stepping motor 105 as the normal direction, and assume the direction opposite to such rotational direction (clockwise direction) as a reverse direction.

Next, when a drive pulse of reverse polarity having a rectangular waveform is supplied to the terminals OUT1, OUT2 of the coil 209 from the drive pulse selection circuit 104 (setting the first terminal OUT1 side as a negative pole, and the second terminal OUT2 side as a positive pole opposite to the polarity relationship of the above-mentioned driving) thus allowing an electric current to flow in the direction opposite to the direction indicated by an arrow shown in FIG. 2, a magnetic flux is generated in the stator 201 in the direction opposite to the direction indicated by the broken-line arrow. Accordingly, the saturable portions 210, 211 are firstly saturated and, thereafter, due to an interaction between a magnetic pole generated in the stator 201 and a magnetic pole of the rotor 202, the rotor 202 is rotated in the same direction (normal direction) as the above-mentioned direction by 180 degrees, and is stably stopped at a position where the magnetic pole axis assumes an angle θ0.

Hereinafter, with the supply of signals which differ in polarity (alternating signals) to the coil 209, the above-mentioned operations are repeatedly performed so that the rotor 202 can be rotated continuously in the direction indicated by the arrow for every 180 degrees. In this embodiment, as the drive pulses, as described later, a plurality of main drive pulses P11 to P1n which differ from each other in energy and a correction drive pulse P2 are used.

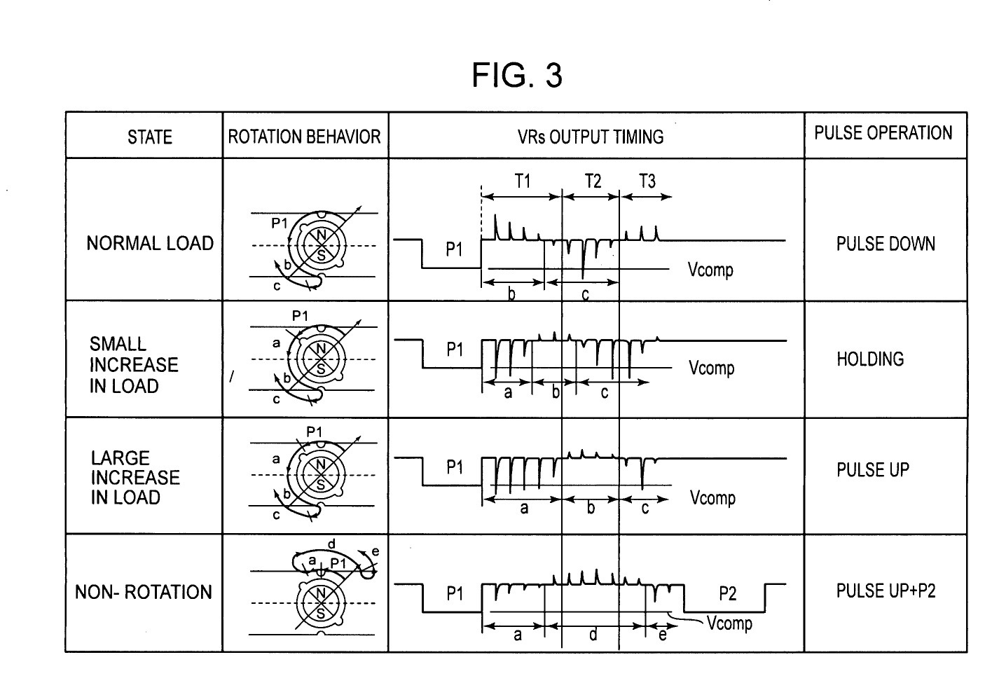

FIG. 3 is a timing chart when the stepping motor 105 is driven with the main drive pulse P1 in this embodiment, wherein a state of a load, the rotational behavior of the rotor 202 and a pulse control operation are indicated along with drive timing of the stepping motor 105.

In FIG. 3, P1 indicates the main drive pulse P1 and, at the same time, indicates an interval during which the rotor 202 is rotatably driven with the main drive pulse P1. Regions a to e are regions indicating positions where the rotor 202 is rotated by free oscillations after stopping driving with the main drive pulse P1.

A predetermined detection interval immediately after driving with the main drive pulse P1 is set as the first interval T1, a predetermined time which comes after the first interval T1 is set as the second interval T2, and a predetermined time which comes after the second interval is set as the third interval T3. In this manner, the whole detection interval T which starts immediately after finishing of driving with the main drive pulse P1 is divided into a plurality of intervals (three intervals T1 to T3 in this embodiment). In this embodiment, a mask interval during which an induction signal VRs is not detected is not provided.

When the XY coordinate space where the main magnetic pole of the rotor 202 is positioned due to the rotation of the rotor 202 is divided into the first quadrant Ito the fourth quadrant IV about the rotor 202, the first interval T1 to the third interval T3 are expressed as follows.

That is, in a normal load state, the first interval T1 is an interval during which a normal-direction rotation state of the rotor 202 in the third quadrant III of the space about the rotor 202 is determined and an interval during which a first reverse-direction rotation state is determined, the second interval T2 is an interval during which the first reverse-direction rotation state of the rotor 202 in the third quadrant III is determined, and the third interval T3 is an interval during which a rotation state of the rotor 202 after the first reverse-direction rotation is determined in the third quadrant III. Here, the normal load implies a load driven during a normal time. In this embodiment, a load which is necessary in driving hands is set as the usual load.

Vcomp is a reference threshold voltage for determining a voltage level of an induction signal VRs generated by the stepping motor 105. The reference threshold voltage Vcomp is set as follows. That is, when the rotor 202 is operated at a fixed speed as in a case where the stepping motor 105 is rotated, an induction signal VRs exceeds the reference threshold voltage Vcomp, while when the rotor 202 is not operated at the fixed speed as in a case where the stepping motor 105 is not rotated, the induction signal VRs does not exceed the reference threshold value Vcomp.

For example, in FIG. 3, in the stepping motor control circuit according to this embodiment, in a usual load state, an induction signal VRs generated in the region b is detected during the first interval T1, an induction signal VRs generated in the region c is detected during the first interval T1 and the second interval T2, and an induction signal VRs generated after the region c is detected during the third interval T3.

Assume a determination value of an interval where the rotation detection circuit 107 detects an induction signal VRs which exceeds the reference threshold voltage Vcomp as “1”, and a determination value of an interval where the rotation detection circuit 107 does not detect the induction signal VRs which exceeds the reference threshold voltage Vcomp as “0”. In an example where a state of the drive load is a usual load shown in FIG. 3, as a pattern of an induction signal VRs indicative of a rotation state (the determination value of the first interval T1, the determination value of the second interval T2, the determination value of the third interval T3), (0, 1, 0) is acquired. In this case, the control circuit 103 determines that drive energy is excessively large (rotation with margin), and performs a pulse control such that the drive energy of the main drive pulse P1 is lowered by 1 rank (pulse down).

Further, in a state where a load increment is small, an induction signal VRs generated in the region a is detected during the first interval T1, an induction signal generated in the region b is detected during the first interval T1 and the second interval T2, and an induction signal generated in the region c is detected during the second interval T2 and the third interval T3. In FIG. 3, the pattern (1, 1, 0) is acquired and hence, the control circuit 103 determines that the drive energy is appropriate (rotation with no margin) and performs a pulse control such that the drive energy of the main drive pulse P1 is maintained with no change.

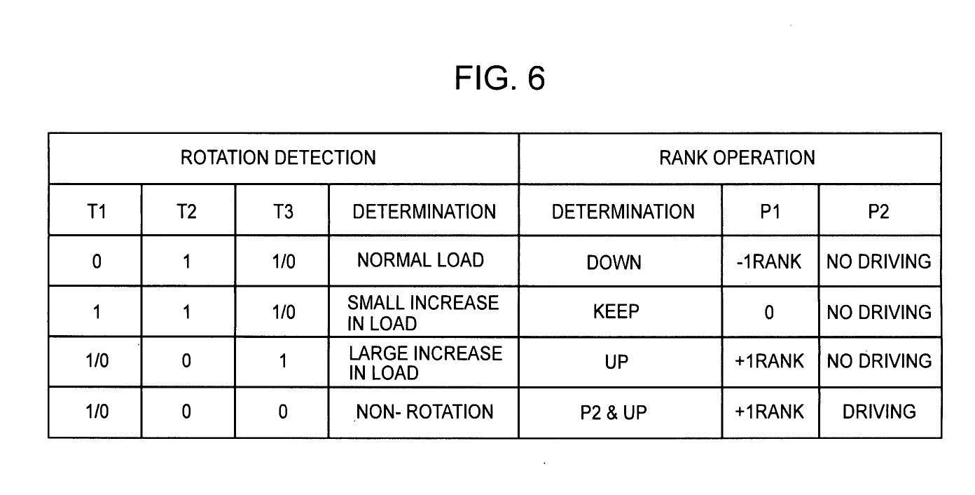

FIG. 6 is a determination chart which summarizes the above-mentioned operations corresponding to the load states. In FIG. 6, as described previously, the determination value of the interval where the rotation detection circuit 107 detects the induction signal VRs which exceeds the reference threshold voltage Vcomp is expressed as “1”, and the determination value of the interval where the rotation detection circuit 107 does not detect the induction signal VRs which exceeds the reference threshold voltage Vcomp is expressed as “0”. Further, “0/1” and “1/0” indicate that the determination value of the interval may be either one of “1” and “0”. The determination chart is preliminarily stored in a memory unit (not shown in the drawing) in the control circuit 103.

As shown in FIG. 6, the rotation detection circuit 107 detects the presence or non-presence of an induction signal VRs which exceeds the reference threshold voltage Vcomp, and the detection interval determination circuit 108 determines the detection timing of the induction signal VRs. Based on a determination pattern, the control circuit 103 looks up the determination chart in FIG. 6 stored therein, and the control circuit 103 and the drive pulse selection circuit 104 perform a drive pulse control described later such as pulse-up or pulse-down of the main drive pulse P1 or driving with a correction drive pulse P2 thus controlling the rotation of the stepping motor 105.

For example, the control circuit 103, when the pattern is (1/0, 0, 0), determines that the stepping motor 105 is not rotated (no rotation), and controls the drive pulse selection circuit 104 such that the stepping motor 105 is driven with the correction drive pulse P2 and, thereafter, the stepping motor 105 is driven with the main drive pulse P1 which is raised by 1 rank at the time of driving the stepping motor 105 next time.

The control circuit 103, when the pattern is (1/0, 0, 1), determines that although the stepping motor 105 is rotated, a load is largely increased compared to the usual load (large load increment) so that there exists a possibility the stepping motor 105 cannot be rotated in the next driving (limit rotation). Based on such determination, to prevent a state where the stepping motor 105 cannot be rotated, the control circuit 103 controls the drive pulse selection circuit 104 such that the stepping motor 105 is driven earlier with the main drive pulse P1 which is raised by 1 rank without driving the stepping motor 105 with the correction drive pulse P2.

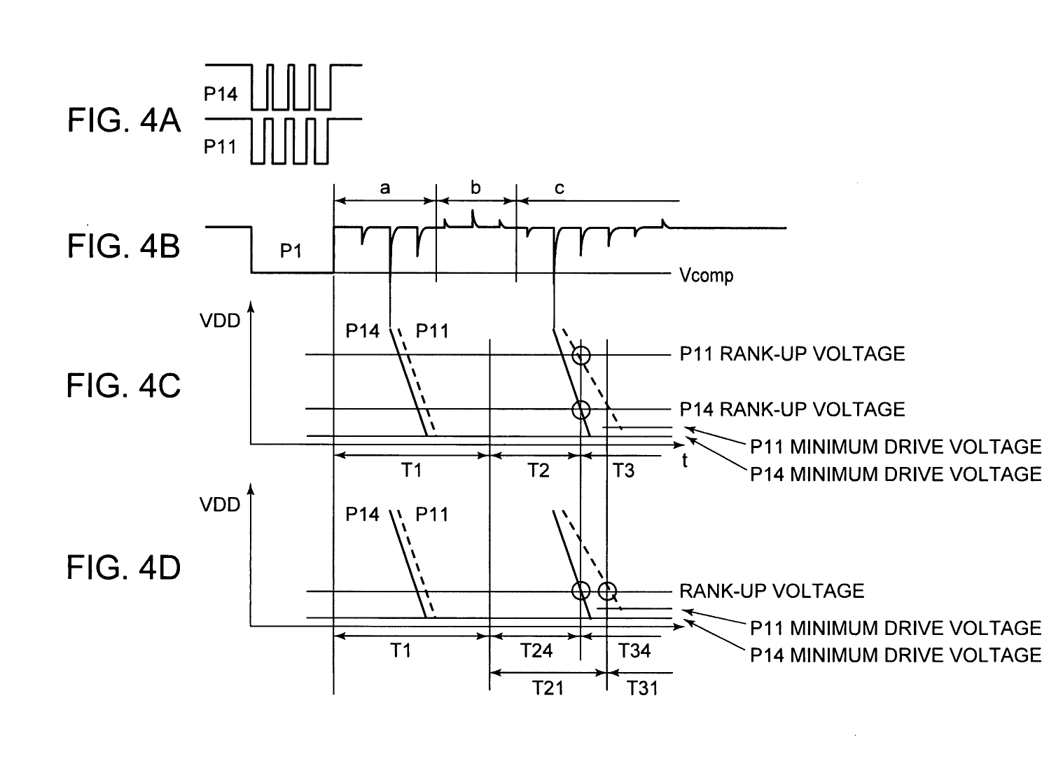

FIG. 4A to FIG. 4D are explanatory views for explaining the manner of operation when the pattern (1,0,1) is generated and the rank of the main drive pulse P1 is raised in this embodiment. Relationship between timing at which induction signal VRs which exceeds the reference threshold voltage Vcomp is detected and a drive voltage is also shown in the drawing along with the pulse rank-up operation.

FIG. 4A is a waveform chart showing waveforms of a main drive pulse P11 whose drive energy rank is at the first rank and a main drive pulse P14 whose drive energy rank is at the fourth rank (P11<P14). A comb-shaped main drive pulse having a fixed pulse width is used as the main drive pulse and a rank of the drive energy is changed by changing a duty ratio. A rectangular-waveform main drive pulse may be used as the main drive pulse. In this case, the rank of the drive energy is changed by changing a pulse width.

FIG. 4B shows the relationship between an induction signal VRs which is generated when the stepping motor 105 is driven with the main drive pulse P1 and the reference threshold voltage Vcomp. In an example shown in the drawing, in regions a, c, an induction signal VRs which exceeds the reference threshold voltage Vcomp is detected. In FIG. 4C and FIG. 4D which are described hereinafter, intervals are set such that a determination value pattern (1, 0, 1) of the induction signal VRs is acquired.

FIG. 4C shows the relationship between a point of time t at which induction signal VRs which exceeds the reference threshold voltage Vcomp is detected and a drive voltage when the second interval T2 is fixed to a predetermined time. FIG. 4C shows a state where a rank-up voltage is changed corresponding to an amount of drive energy of a main drive pulse. Here, the rank-up voltage is a drive voltage which is used for driving the stepping motor 105 by raising the rank of a main drive pulse P1 without performing driving with a correction drive pulse P2. To be more specific, the rank-up voltage is a drive voltage which is formed by raising the rank of the main drive pulse in response to the generation of the pattern (0/1, 0, 1).

A broken line indicates the relationship between the point of time t at which the induction signal VRs which exceeds the reference threshold voltage Vcomp is generated and a drive voltage when the stepping motor 105 is driven with a main drive pulse P11, and a solid line indicates the relationship between the point of time t at which the induction signal VRs which exceeds the reference threshold voltage Vcomp is generated and a drive voltage when the stepping motor 105 is driven with a main drive pulse P14. Here, the minimum drive voltage P11 and the minimum drive voltage P14 are respectively minimum drive voltages which can drive the stepping motor 105 with the main drive pulses P11, P14 respectively.

When the stepping motor 105 is driven with either one of the main drive pulses P11, P14, the rotation of the stepping motor 105 becomes slow along with lowering of the drive voltage and hence, the timing at which the induction signal VRs which exceeds the reference threshold voltage Vcomp is generated is delayed. The longer an elapsed time from starting of driving with the main drive pulse, the more apparent this phenomenon becomes. For example, compared to the first interval T1, in the third interval T3, the driving with the main drive pulse P11 is performed later than the driving with the main drive pulse P14.

When the stepping motor 105 is driven with either one of the main drive pulses P11, P14, the determination value “1” is acquired in the first interval T1, the determination value “0” is acquired in the second interval T2, and the determination value “1” is acquired in the third interval T3. A length of the second interval is set to a fixed value and hence, when the stepping motor 105 is driven with either one of the main drive pulses P11, P14, the determination value “1” is detected at the same point of time that the drive pulses P11, P14 enter the third interval T3 as indicated by a circle mark, and the control circuit 103 determines that the pattern (1,0,1) is generated at this point of time. Accordingly, as shown in the drawing, the rank-up voltage at the time of driving the stepping motor 105 with the main driving pulse P11 becomes a value larger than a rank-up voltage at the time of driving the stepping motor 105 with the main driving pulse P14.

In this manner, the smaller an amount of an energy of the main drive pulse, a rotational speed of the rotor 202 is decreased so that the generation timing of the induction signal VRs in the third quadrant III is delayed. When the third interval T3 is set by performing the optimization in conformity with the rank-up available driving of the stepping motor 105 with the drive pulse P14 of high amount of energy, the rank-up is performed with a voltage which is unnecessarily high with respect to the minimum drive voltage in case of the driving of the stepping motor 105 with the drive pulse P11 of small amount of energy and hence, the reduction of power consumption is limited.

FIG. 4D is a view for explaining an operation of this embodiment which is provided for overcoming such a drawback explained in conjunction with FIG. 4C.

That is, in this embodiment, as shown in FIG. 4D, the control circuit 103 performs a control such that a length of the second interval T2 is changed corresponding to drive energy of the main drive pulse P1 (a duty ratio in case of a comb-teeth-shaped main drive pulse and a pulse width in case of a rectangular-shaped main drive pulse). In the example shown in FIG. 4D, the control circuit 103 set the second interval T2 such that the smaller the drive energy of the main drive pulse P1 (the lower the rank of the drive energy), the longer the second interval T2 becomes. Further, the control circuit 103 changes a length of the second interval T2 such that the difference among rank-up voltages of the respective main drive pulses P1 falls within a predetermined range or, preferably, the rank-up voltages become equal to each other. Further, the control circuit 103 shortens the length of the third interval T3 corresponding to a change amount of the second interval T2 such that the total length of the detection interval T is not changed.

In other words, the control circuit 103 performs a control such that a start timing of the third interval T3 is changed corresponding to the energy (to be more specific, rank of drive energy) set for every predetermined main drive pulse P1. In the example shown in FIG. 4D, the control circuit 103 sets the start timing of the third interval T3 such that the smaller the energy of the predetermined main drive pulse P1 (the lower the rank of the drive energy becomes), the more the start timing of the third interval T3 is delayed. Further, the control circuit 103 changes a start timing of the third interval T3 such that the difference among rank-up voltages of the respective main drive pulses P1 falls within a predetermined range or, preferably, becomes equal to each other. Further, the control circuit 103 changes the length of the second interval T2 corresponding to a change amount in start timing of the third interval T3 such that the total length of the detection interval T is not changed.

In FIG. 4D, the first interval is set to T1, the second interval is set to T21 and the third interval is set to T31 with respect to the main drive pulse P11, while the first interval is set to T1 in the same manner as the main drive pulse P11, the second interval is set to T24 which is shorter than T21 and the third interval is set to T34 which is longer than T31 with respect to the main drive pulse P14. Here, in a case where the whole detection interval T become equal with respect to the respective main drive pulses, a sum of the second interval T21 and the third interval T31 with respect to the main drive pulse P11 is set equal to a sum of the second interval T24 and the third interval T34 with respect to the main drive pulse P14.

The control circuit 103 preliminarily stores an interval table which makes the respective main drive pulses P1 and the length of the second interval T2 correspond to each other in a memory unit thereof. The control circuit 103 selects the second interval T2 of a length corresponding to the present main drive pulse P1 by looking up the interval table at the time of detecting the rotation of the rotor 202. The control circuit 103 may store the length of the third interval together with the length of the second interval in the interval table, wherein the first interval may be set to a fixed value and the third interval may be changed together with the second interval. The detection interval determination circuit 108 acquires determination values of induction signals VRs which the rotation detection circuit 107 detects in the respective intervals using the respective first to third intervals of lengths set by the control circuit 103.

In FIG. 4D, when the stepping motor 105 is driven with the main drive pulse P11, the determination value “1” is acquired in the first interval T1, the determination value “0” is acquired in the second interval T21, and the determination value “1” is acquired in the third interval T31 as indicated by a circle mark. Further, when the stepping motor 105 is driven with the main drive pulse P14, the determination value “1” is acquired in the first interval T1, the determination value “0” is acquired in the second interval T24, and the determination value “1” is acquired in the third interval T34 as indicated by a circle mark. In both of the main drive pulses P11, P14, it is determined that the pattern (1, 0, 1) is generated at a point of time indicated by the circle mark. In this case, the rank-up voltages are equal, and the rank-up voltages are set higher than the minimum drive voltages of the respective main drive pulses.

In this manner, the rank-up voltage can be set to a low value by changing the length of the second interval T2 to a length T2n corresponding to energy of each main drive pulse so that it is possible to reduce power consumption by lowering the rank-up voltage for every main drive pulse. Further, it is possible to optimize the rank change operation of the main drive pulse by properly determining the available driving force thus realizing the reduction of power consumption.

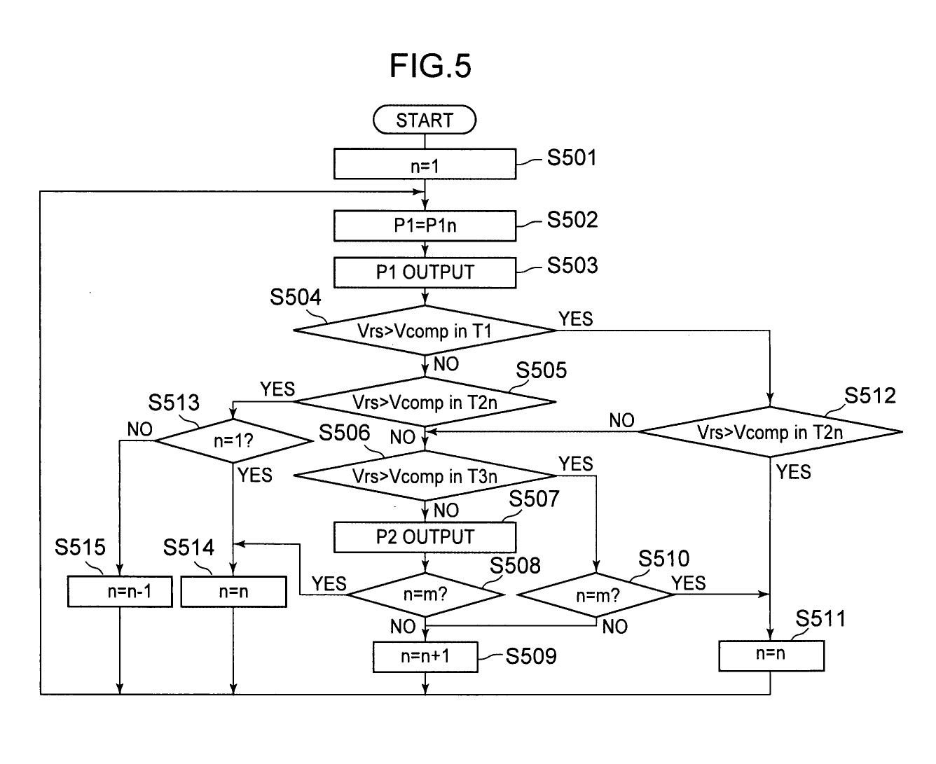

FIG. 5 is a flowchart indicating the manner of operation of the stepping motor control circuit and the analogue electronic timepiece according to the embodiment of the present invention. FIG. 5 mainly shows the flowchart indicating the processing of the control circuit 103.

Hereinafter, the manner of operation of the stepping motor control circuit and the analogue electronic timepiece according to the embodiment of the present invention is explained in detail in conjunction with FIG. 1 to FIG. 6.

In FIG. 1, the oscillation circuit 101 generates a reference timepiece signal of predetermined frequency. The frequency dividing circuit 102 generates a timepiece signal which becomes the reference in counting time by dividing the frequency of the signal generated by the oscillation circuit 101, and outputs the timepiece signal to the control circuit 103.

The control circuit 103 performs a time counting operation by counting the number of time signals and, first of all, sets the rank of the main drive pulse P1n to 1 (step S501 in FIG. 5), and outputs the control signal which allows the stepping motor 105 to be rotationally driven with the main drive pulse P11 of minimum drive energy (step S502, S503).

The drive pulse selection circuit 104 rotationally drives the stepping motor 105 with the main drive pulse P11 in response to the control signal from the control circuit 103. The stepping motor 105 is rotationally driven with the main drive pulse P11 and the analogue display part 106 is driven. Accordingly, when the stepping motor 105 is normally rotated, a present time is displayed by hands on the analogue display part 106 at any time.

After rotationally driving the stepping motor 105, the control circuit 103 sets the first to third intervals to intervals having lengths which correspond to ranks of the main drive pulses P1 by looking up the interval table which is preliminarily stored in the control circuit 103, and the control circuit 103 determines the rotation state of the stepping motor 105.

The control circuit 103 determines whether or not the rotation detection circuit 107 detects the induction signal VRs of the stepping motor 105 which exceeds a predetermined reference threshold voltage Vcomp and whether or not the detection interval determination circuit 108 determines that a detection time t of the induction signal VRs falls within the first interval T1 (that is, whether or not the induction signal VRs which exceeds a reference threshold voltage Vcomp is detected within the first interval T1) (step S504). When the control circuit 103 determines that the induction signal VRs which exceeds the reference threshold voltage Vcomp is not detected within the first interval T1, the control circuit 103 determines whether or not the induction signal VRs which exceeds a reference threshold voltage Vcomp is detected within the second interval T2n in the same manner (step S505).

In processing step S505, when the control circuit 103 determines that the induction signal VRs which exceeds the reference threshold voltage Vcomp is not detected within the second interval T2n, the control circuit 103 determines whether or not the induction signal VRs which exceeds a reference threshold voltage Vcomp is detected within the third interval T3n in the same manner (step S506).

In processing step S506, when the control circuit 103 determines that the induction signal VRs which exceeds the reference threshold voltage Vcomp is not detected within the third interval T3n, the control circuit 103 drives the stepping motor 105 with a correction drive pulse P2 (step S507). Thereafter, when the rank n of the main drive pulse P1 is not a maximum rank m, the control circuit 103 changes the main drive pulse P1 to a main drive pulse P1 (n+1) by raising the rank of the main drive pulse P1 by 1 rank and, then, returns the processing to processing step S502, and performs the next driving of the stepping motor 105 with the main drive pulse P1 (n+1) (step S508, S509; non-rotation state shown in FIG. 3 and FIG. 6).

In processing step S508, when the rank n of the main drive pulse P1 is the maximum rank m, the control circuit 103 returns the processing to processing step S502 without changing the main drive pulse P1 (step S514).

In processing step S506, when the control circuit 103 determines that the induction signal VRs which exceeds the reference threshold voltage Vcomp is detected within the third interval T3 (when the determined value pattern shown in FIG. 4D is (0/1, 0, 1) corresponding to the large load increment state shown in FIG. 3 and FIG. 6) and when the rank n of the main drive pulse P1 is not the maximum rank m (step S508), the control circuit 103 changes the main drive pulse P1 to the main drive pulse P1 (n+1) by raising the rank of the main drive pulse P1 by 1 rank and returns the processing to processing step S502, and the control circuit 103 performs the next-time driving of the stepping motor 105 with the main drive pulse P1 (step S510, S509).

In this manner, instead of uniformly determining the rotation state of the stepping motor 105 within the same detection interval irrespective of an amount of energy of the main drive pulse (see FIG. 4C), a length of the interval is changed corresponding to the amount of energy of the main drive pulse. Due to such changing of the length of the interval, degree of available rank-up driving in all ranks of the main drive pulse is optimized thus realizing the reduction of the power consumption. That is, a rank change operation of the main drive pulse can be optimized by properly determining an available driving force thus realizing the reduction of the power consumption.

In processing step S510, when the rank n of the main drive pulse P1 is the maximum rank m, the control circuit 103 cannot change a rank of the main drive pulse P1. Accordingly, the control circuit 103 maintains the main drive pulse P1 with no change and returns the processing to processing step S502, and performs the next-time driving of the stepping motor 105 with this main drive pulse P1 (step S511).

In processing step S504, when the control circuit 103 determines that the induction signal VRs which exceeds the reference threshold voltage Vcomp is detected within the first interval T1, the control circuit 103 determines whether or not the induction signal VRs which exceeds the reference threshold voltage Vcomp is detected within the second interval T2n in the same manner (step S512).

In processing step S512, when the control circuit 103 determines that the induction signal VRs which exceeds the reference threshold voltage Vcomp is not detected within the second interval T2n, the control circuit 103 advances the processing to processing step S506, and executes the above-mentioned processing.

In processing step S512, when the control circuit 103 determines that the induction signal VRs which exceeds the reference threshold voltage Vcomp is detected within the second interval T2, the control circuit 103 advances the processing to processing step S511 (small load increment state shown in FIG. 3 and FIG. 6).

On the other hand, in processing step S505, when the control circuit 103 determines that the induction signal VRs which exceeds the reference threshold voltage Vcomp is detected within the second interval T2n (usual load state shown in FIG. 3 and FIG. 6), and when the rank n of the main drive pulse P1 is the minimum rank 1, the control circuit 103 cannot lower the rank of the main drive pulse P1 and hence, the control circuit 103 returns the processing to processing step S502 without changing the rank of the main drive pulse P1 (step S513, S514), and when the rank n of the main drive pulse P1 is not the minimum rank 1, the control circuit 103 lowers the main drive pulse P1 by 1 rank, and returns the processing to processing step S502 (step S513, S515). Due to such an operation, when an available driving force is further larger, the pulse-down of the main drive pulse P1 is immediately performed so that the stepping motor 5 can maintain stable driving and, at the same time, can realize the reduction of power consumption.

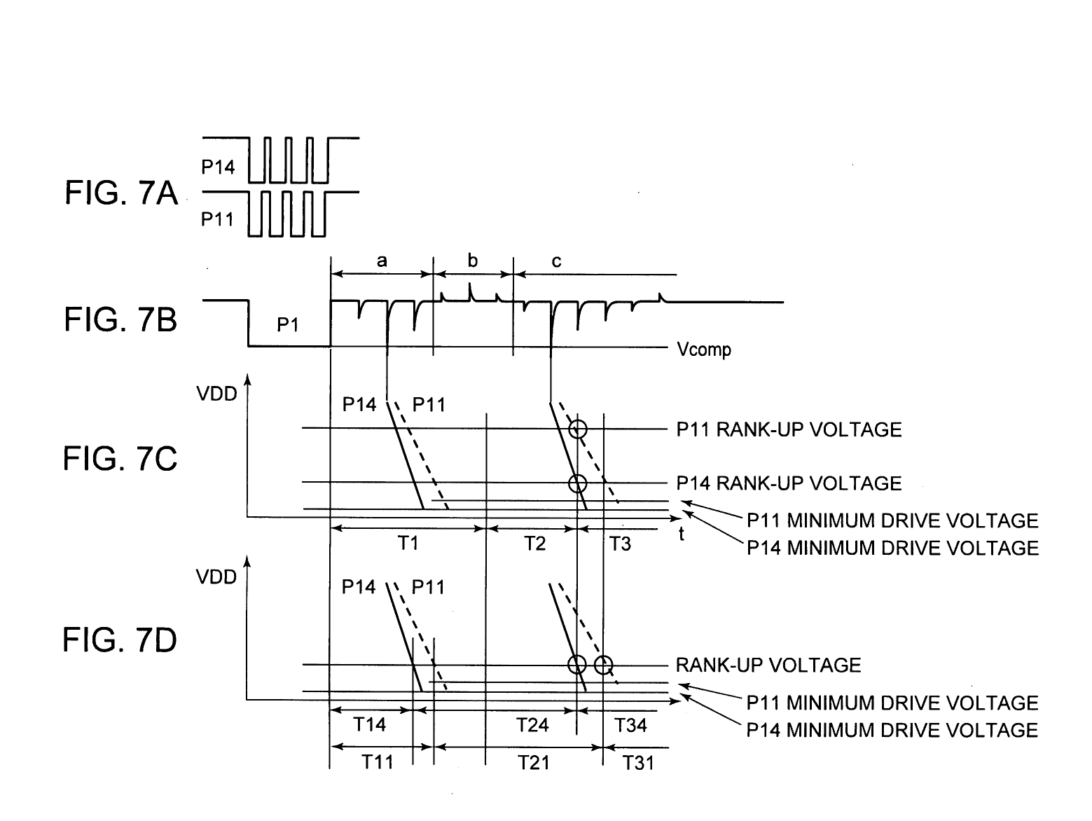

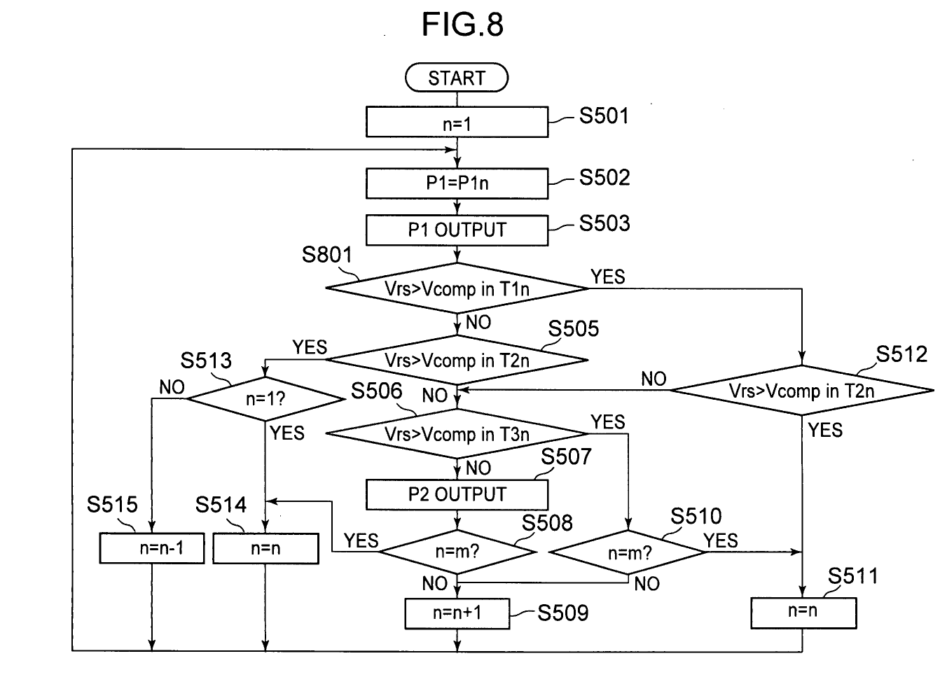

FIGS. 7A to 7D are explanatory views for explaining the manner of operation of another embodiment of the present invention, and FIG. 8 is a flowchart showing the manner of operation of another embodiment of the present invention. FIGS. 7A to 7D and FIG. 8 correspond to FIGS. 4A to 4D and FIG. 5 respectively. The same symbols are given to identical parts.

In the previously-mentioned embodiment, the start timing of one interval is delayed corresponding to ranks of the main drive pulses P1. In this embodiment, timings within a plurality of intervals are delayed corresponding to ranks of the main drive pulses P1.

Hereinafter, the manner of operation of this embodiment is explained with respect to parts of the operation which differ from the corresponding parts of the operation of the previously-mentioned embodiment.

This embodiment is equal to the above-mentioned embodiment with respect to the block diagram and the pulse control operation. In this embodiment, however, a control circuit 103 preliminarily stores an interval table which makes start timing of a second interval T2 and start timing of a third interval T3 correspond to each other for every main drive pulse P1 in a memory unit thereof. The control circuit 103 looks up the interval table at the time of detecting the rotation, and the control circuit 103 sets the start timings of the second interval T2 and the third interval T3 to predetermined timings corresponding to energy ranks of main drive pulses P1. Also in this case, a length of a detection interval T is set to a fixed value.

For example, in the example shown in FIG. 7D, the detection interval T which is set corresponding to the main drive pulse P11 is divided into the first interval T11, the second interval T21 and the third interval T31, while the detection interval T which is set corresponding to the main drive pulse P14 is divided into the first interval T14, the second interval T24 and the third interval T34. Further, the start timing of the second interval T21 is set to come after the start timing of the second interval T24, and the start timing of the third interval T31 is set to come after the start timing of the third interval T34. A rotation state is determined in a state where the detection interval T is divided corresponding to energy of the main drive pulse P1.

Further, in FIGS. 4A to 4D, the minimum drive voltage P11 and the minimum drive voltage P14 which are the minimum drive voltages capable of rotating the stepping motor 105 with the main drive pulses P11, P14 are omitted from the drawing. In FIGS. 7A to 7D, however, the minimum drive voltage P11 and the minimum drive voltage P14 are explicitly described.

In FIG. 1, the control circuit 103 performs a time counting operation by counting the number of time signals from a frequency dividing circuit 102, sets the rank of the main drive pulse P1n to 1, and outputs the control signal for rotationally driving the stepping motor 105 with the main drive pulse P11 of minimum drive energy (steps S501 to S503 in FIG. 8).

The drive pulse selection circuit 104 rotationally drives the stepping motor 105 with the main drive pulse P11 in response to the control signal from the control circuit 103. The stepping motor 105 is rotationally driven with the main drive pulse P11 thus driving the analogue display part 106. Due to such an operation, when the stepping motor 105 is normally rotated, the analogue display part 106 performs a display of present time using hands all the time.

After rotationally driving the stepping motor 105, the control circuit 103 sets the start timings of the second and third intervals corresponding to ranks of the main drive pulses P1 by looking up the interval table which is preliminarily stored in the control circuit 103, and the control circuit 103 determines the rotation state of the stepping motor 105. That is, the control circuit 103 looks up the interval table, sets the start timings of the second and third intervals such that the smaller the rank of the main drive pulse P1, the more the start timings of the second and third intervals are delayed, and the control circuit 103 determines the rotation state of the stepping motor 105.

The control circuit 103 determines whether or not the rotation detection circuit 107 detects the induction signal VRs of the stepping motor 105 which exceeds a predetermined reference threshold voltage Vcomp and whether or not the detection interval determination circuit 108 determines that a detection time t of the induction signal VRs falls within the first interval T1n (here, first interval T11 since n=1) (that is, the determination whether or not the induction signal VRs which exceeds a reference threshold voltage Vcomp is detected within the first interval Tln) (step S801). When the control circuit 103 determines that the induction signal VRs which exceeds the reference threshold voltage Vcomp is not detected within the first interval Tln, the control circuit 103 executes processing in processing step S505 and processing steps which come after processing step S505 in the same manner as described above.

Further, when the control circuit 103 determines that the induction signal VRs which exceeds the reference threshold voltage Vcomp is detected within the first interval Tln in processing step S801, processing in processing step S512 and processing steps which come after processing step S512 are executed in the same manner as described above.

In this embodiment, the control circuit 103 delays the start timings of the second interval T2 and the third interval T3 such that the smaller the energy of the main drive pulse P1, the more the start timings of the second interval T2 and the third interval T3 are delayed, and the control circuit 103 determines the rotation state. Accordingly, the available driving force can be properly determined so that a rank change operation of the main drive pulse P1 can be optimized thus realizing the reduction of power consumption. Further, the degree of rank-up available driving can be optimized thus realizing the reduction of power consumption.

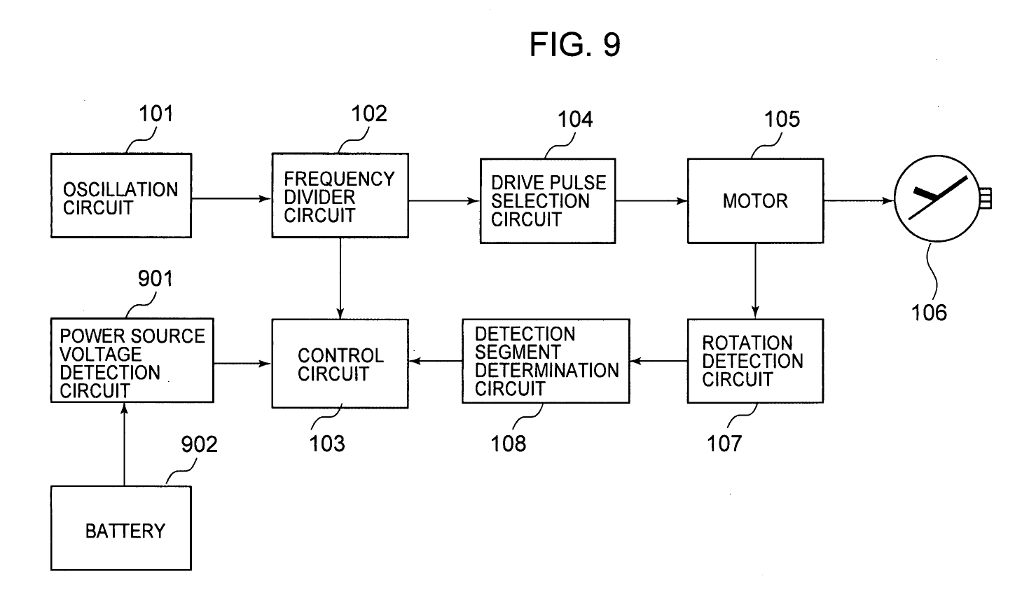

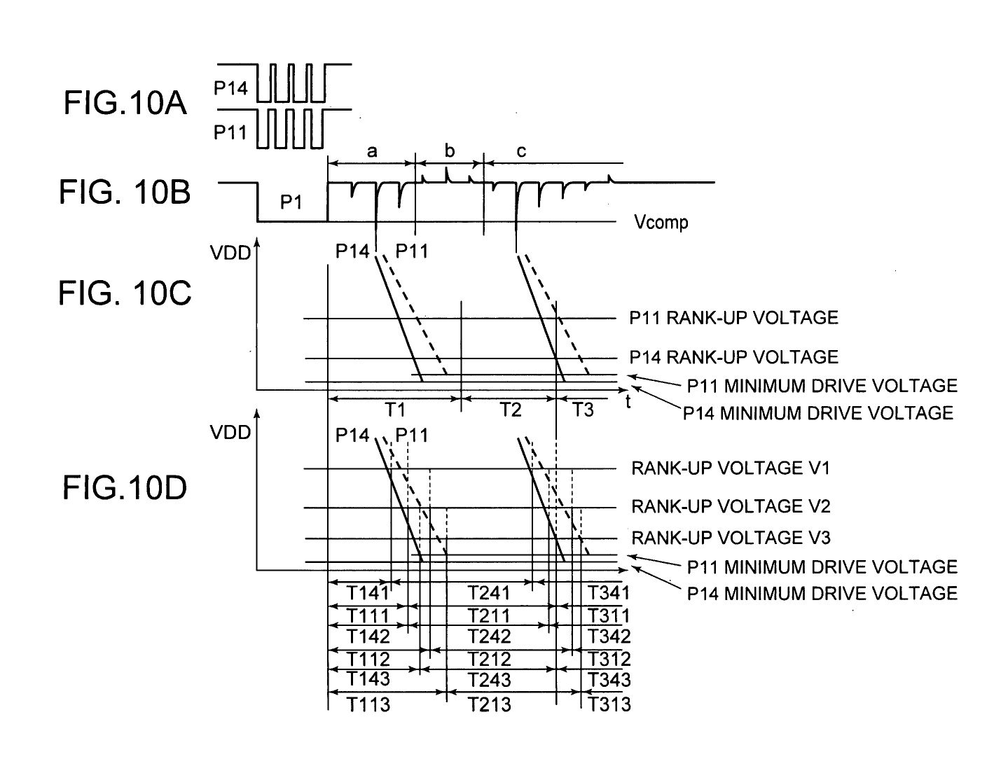

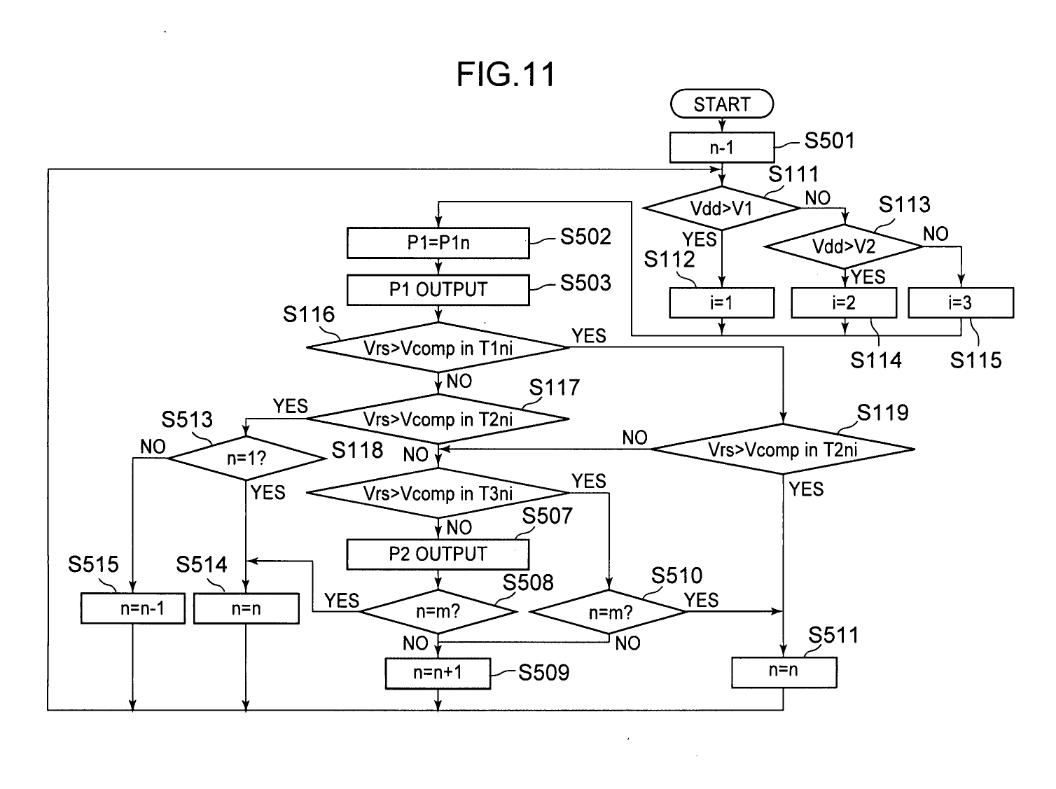

FIG. 9 is a block diagram of an analogue electronic timepiece which uses a motor control circuit according to still another embodiment of the present invention, FIGS. 10A to 10D are explanatory views for explaining the manner of operation of this embodiment of the present invention, and FIG. 11 is a flowchart showing the manner of operation of this embodiment of the present invention. FIG. 9, FIGS. 10A to 10D and FIG. 11 correspond to FIG. 1, FIGS. 4A to 4D and FIG. 5 respectively. The same symbols are given to identical parts.

In FIG. 9, in this embodiment, the analogue electronic timepiece includes a battery 902 as a power source which drives electronic constitutional elements of the analogue electronic timepiece including a stepping motor 105 and a stepping motor control circuit. The analogue electronic timepiece also includes a power source voltage detection circuit 901 which detects a voltage of the battery 902. Here, the power source voltage detection circuit 901 constitutes a power source voltage detection unit. Further, a control circuit 103, a drive pulse selection circuit 104, a detection interval determination circuit 108 and the power source voltage detection circuit 901 constitute a control unit.

In this embodiment, the control circuit 103 preliminarily stores an interval table which makes the main drive pulses P1 of respective ranks, a predetermined power source voltage and start timings of the second interval T2 and the third interval T3 correspond to each other in a memory unit thereof. The control circuit 103 looks up the interval table at the time of detecting the rotation, and sets the start timings of the second interval T2 and the third interval T3 to timings corresponding to the preset energy rank of the main drive pulse P1 and the voltage of the battery 902 which the power source voltage detection circuit 901 detects. In this manner, according to this embodiment, the start timings in a plurality of intervals are changed corresponding to the energy rank of the main drive pulse P1 and the voltage value of the power source. Also in this case, the length of the detection interval T is set to a fixed value.

The manner of operation of this embodiment is explained in detail with respect to parts which makes this embodiment different from the above-mentioned respective embodiments.

In FIG. 11, the control circuit 103 performs a time counting operation by counting the number of time signals from a frequency dividing circuit 102 and sets the rank of the main drive pulse P1n to 1 (step S501), and the control circuit 103 determines an amount of voltage Vdd of the battery 902 which the power source voltage detection circuit 901 detects (steps S111, S113).

The control circuit 103 sets the rank-up voltage kind i to 1 (that is, rank-up voltage V1) when the voltage Vdd of the battery 902 exceeds a predetermined first rank-up voltage (first voltage) V1 (step S112; see FIG. 10D). The control circuit 103 looks up the interval table which the control circuit 103 per se preliminarily stores, and sets the start timings of the second interval and the third interval corresponding to the ranks of the main drive pulses P1 and the rank-up voltage kind i. Here, the length of the detection interval T is also set to a fixed value.

In this case, the rank n of the main drive pulse P1 is 1 and the rank-up voltage kind i is 1 and hence, as shown in FIG. 10D, the detection interval T is divided into the first interval T111, the second interval T211 and the third interval T311. When the main drive pulse P1 is the main drive pulse P14, the detection interval T is divided into the first interval T141, the second interval T241 and the third interval T341. That is, the control circuit 103 looks up the interval table, sets the start timings of the second and third intervals such that the smaller the rank of the main drive pulse P1 and the lower the power source voltage which is raised, the more the start timings of the second interval and the third interval are delayed, and the control circuit 103 determines the rotation state of the stepping motor 105.

When the control circuit 103 determines that the voltage Vdd of the battery 902 does not exceed the first rank-up voltage V1 in processing step S111, and determines that the voltage Vdd of the battery 902 exceeds the second rank-up voltage (second voltage) V2 (V2<V1) (step S113), the rank-up voltage kind i is set to 2 (that is, rank-up voltage V2) (step S114). In this case, as shown in FIG. 10D, the detection interval T is divided into the first interval T112, the second interval T212 and the third interval T312, while when the main drive pulse P1 is the main drive pulse P14, the detection interval T is divided into the first interval T142, the second interval T242 and the third interval T342.

When the control circuit 103 determines that the voltage Vdd of the battery 902 does not exceed the second rank-up voltage V2 in processing step S113, the rank-up voltage kind is set to 3 (that is, rank-up voltage (third voltage) V3 (V3<V2)) (step S115). In this case, as shown in FIG. 10D, the detection interval T is divided into the first interval T113, the second interval T213 and the third interval T313, while the detection interval T is divided into the first interval T143, the second interval T243 and the third interval T343 when the main drive pulse P1 is the main drive pulse P14.

Next, the control circuit 103 outputs a control signal which allows the stepping motor 105 to be rotated with the main drive pulse P11 of minimum drive energy (steps S502, S503).

The drive pulse selection circuit 104 rotationally drives the stepping motor 105 with the main drive pulse P11 in response to the control signal from the control circuit 103. The stepping motor 105 is rotatably driven with the main drive pulse P11 and the analogue display part 106 is driven. Accordingly, when the stepping motor 105 is normally rotated, a present time is displayed by hands on the analogue display part 106 at any time.

After rotationally driving the stepping motor 105, using the detection interval T which is set as described above, the control circuit 103 determines the rotation state of the stepping motor 105 based on a detection result of the rotation detection circuit 107 and an interval determination result of the detection interval determination circuit 108.

That is, the control circuit 103 determines whether or not the rotation detection circuit 107 detects the induction signal VRs of the stepping motor 105 which exceeds a predetermined reference threshold voltage Vcomp and whether or not the detection interval determination circuit 108 determines that a detection time t of the induction signal VRs falls within the first interval T1ni (here, first interval T111 since n=1, i=1) (that is, whether or not the induction signal VRs which exceeds a reference threshold voltage Vcomp is detected within the first interval T1ni) (step S116).

In processing step S116, when the control circuit 103 determines that the induction signal VRs which exceeds the reference threshold voltage Vcomp is not detected within the first interval T1ni, the control circuit 103 determines whether or not the induction signal VRs which exceeds a reference threshold voltage Vcomp is detected within the second interval T2ni (here, second interval T211) (step S117).

In processing step S117, when the control circuit 103 determines that the induction signal VRs which exceeds the reference threshold voltage Vcomp is not detected within the second interval T2ni, the control circuit 103 determines whether or not the induction signal VRs which exceeds a reference threshold voltage Vcomp is detected within the third interval T3ni (here, third interval T311) (step S118), and executes processing which comes after processing step S507 or processing which comes after processing step S510 corresponding to the determination result.

In processing step S117, when the control circuit 103 determines that the induction signal VRs which exceeds the reference threshold voltage Vcomp is detected within the second interval T2ni, the control circuit 103 executes processing which comes after processing step S513.

In processing step S116, when the control circuit 103 determines that the induction signal VRs which exceeds the reference threshold voltage Vcomp is detected within the first interval Tlni, and when the control circuit 103 determines that the induction signal VRs which exceeds the reference threshold voltage Vcomp is detected within the second interval T2ni, the control circuit 103 executes processing which comes after processing step S511. When the control circuit 103 determines that the induction signal VRs which exceeds the reference threshold voltage Vcomp is not detected within the second interval T2ni, the control circuit 103 executes processing which comes after processing step S118 (step S119).

By repeating the above-mentioned processing corresponding to the rank of the main drive pulse P1 and a power source voltage, a pulse control is performed by detecting a rotation state of the stepping motor 105 thus controlling the rotation of the stepping motor 105.

According to this embodiment, the control circuit 103 delays the start timings of the second interval T2 and the third interval T3 such that the lower the voltage of the battery 902 which constitutes the power source and the smaller the energy of the main drive pulse P1, and the control circuit 103 determines the rotation state. Accordingly, it is possible to acquire advantageous effects that by properly determining the available driving force, the rank change operation of the main drive pulse P1 can be optimized thus acquiring an advantageous effect that the reduction of power consumption can be realized. Further, by optimizing the degree of rank-up available driving, it is possible to realize the reduction of power consumption.

Further, compared to a small battery voltage change amount of approximately 1.57 to 1.3V of a conventional silver oxide battery, a change amount of a battery voltage of a solar timepiece or the like is large, that is, 2.3V to 1.0V. In such a case, when the detection interval is set to a lower voltage side, timing of an induction voltage is not shifted to the detection interval even when a load is increased on a high voltage side thus giving rise to a possibility that the increase of the load cannot be detected so that the available driving cannot be ensured. According to this embodiment, by changing the detection interval T corresponding to the value of the power source voltage, it is possible to realize the reduction of power consumption while ensuring the degree of rank-up available driving from the high voltage to the low voltage.

In this embodiment, the start timings of the second interval T2 and the third interval T3 are changed by taking the power source voltage and the main drive pulse energy into consideration. However, only the start timing of the third interval T3 can be changed by taking the power source voltage and the main drive pulse energy into consideration. For example, the control unit may be configured to delay the start timing of the third interval T3 such that the lower the voltage of the power source and the smaller energy of the main drive pulse, the more the start timing of the third interval T3 is delayed, and to determine the rotation state.

Further, the control unit may be configured to delay only the start timing of the third interval T3 by taking only the voltage of the power source into consideration without taking energy of the main drive pulse P1 into consideration such that the lower the voltage of the power source, the more only the start timing of the third interval T3 is delayed, and to determine the rotation state.

Further, the control unit may be configured to delay the start timings of the second interval T2 and the third interval T3 by taking only the voltage of the power source into consideration without taking energy of the main drive pulse P1 into consideration such that the lower the voltage of the power source, the more the start timings of the second interval T2 and the third interval T3 are delayed, and to determine the rotation state.

As has been explained above, the stepping motor control circuit according to the embodiments of the present invention includes: the rotation detection unit which detects an induction signal VRs which is generated in response to rotation of the rotor 202 of the stepping motor 105, and detects a rotation state of the stepping motor 105 based on whether or not the induction signal VRs exceeds a predetermined reference threshold voltage Vcomp within a predetermined detection interval T; and the control unit which performs a drive control of the stepping motor 105 with any one of a plurality of main drive pulses P1 which differ in energy from each other or a correction drive pulse P2 having larger energy than the respective main drive pulses P1 corresponding to a detection result of the rotation detection unit, wherein the detection interval T is divided into a plurality of intervals, and the control unit performs a control of changing start timing of the interval corresponding to an amount of drive energy of the stepping motor 105.

Accordingly, the rank change operation of the main drive pulse P1 can be optimized by properly determining the available driving force thus realizing the reduction of power consumption. Further, it is possible to obtain an advantageous effect that the reduction of power consumption can be realized by optimizing the degree of rank-up available driving.

Here, the control unit may be configured to perform a change control of start timing of the interval corresponding to an amount of energy set for the above-mentioned every main drive pulse P1.

Further, the stepping motor control circuit may include a power source for driving the stepping motor 105, and the control unit may be configured to perform a change control of start timing of the interval corresponding to an amount of energy set for every main drive pulse P1 and corresponding to an amount of voltage of the power source. Due to such a constitution, start timing of the interval is set to timing corresponding to at least an amount of the power source voltage thus realizing the more accurate determination of the rotation state.

In the above-mentioned respective embodiments, the duty ratio or the pulse width is changed for changing energy ranks of the respective main drive pulses P1. However, the drive energy may be changed by changing a pulse voltage or the like.

Further, the electronic timepiece is exemplified as an application example of the stepping motor in the above-mentioned respective embodiments. However, the present invention is applicable to an electronic device which uses a motor.

### INDUSTRIAL APPLICABILITY

The stepping motor control circuit according to the present invention is applicable to various electronic devices which uses a stepping motor.

Further, the electronic timepiece according to the present invention is applicable to various analogue electronic timepieces including various kinds of analogue electronic timepieces having a calendar function such as an analogue electronic watch having a calendar function and an analogue electronic stand timepiece having a calendar function.

What is claimed is:

1. A stepping motor control circuit comprising:
a rotation detection unit which detects an induction signal which is generated in response to rotation of a rotor of a stepping motor, and detects a rotation state of the stepping motor based on whether or not the induction signal exceeds a predetermined reference threshold voltage within a predetermined detection interval; and
a control unit which performs a drive control of the stepping motor with any one of a plurality of main drive pulses which differ in energy from each other or a correction drive pulse having larger energy than the respective main drive pulses corresponding to a detection result of the rotation detection unit, wherein
the detection interval is divided into a plurality of intervals, and
the control unit performs a control of changing start timing of the interval corresponding to an amount of drive energy of the stepping motor.

2. A stepping motor control circuit according to claim 1, wherein the control unit performs the control of changing the start timing of the interval corresponding to the amount of energy determined for every main drive pulse.

3. A stepping motor control circuit according to claim 1, wherein the stepping motor control circuit includes a power source for driving the stepping motor, and
the control unit performs the control of changing the start timing of the interval corresponding to the amount of energy determined for every main drive pulse and an amount of voltage of the power source.

4. A stepping motor control circuit according to claim 1, wherein the detection interval is divided into a first interval immediately after driving with the main drive pulse, a second interval which comes after the first interval, and a third interval which comes after the second interval, and in a usual load state, the first interval is an interval in which a normal-direction rotation state of the rotor is determined and an interval in which a first reverse-directional rotation state of the rotor is determined in a third quadrant of a space about the rotor, the second interval is an interval in which the first reverse-directional rotation state of the rotor is determined in the third quadrant, and the third interval is an interval in which a rotation state of the rotor after the first reverse-directional rotation is determined in the third quadrant, and
the control unit sets the second interval such that the smaller the energy of the main drive pulse, the longer the second interval becomes, and the control unit determines the rotation state.

5. A stepping motor control circuit according to claim 4, wherein the control unit changes the second interval such that the difference among rank-up voltages of the respective main drive pulses falls within a predetermined range, and the control unit determines the rotation state.

6. A stepping motor control circuit according to claim 5, wherein the control unit changes the second interval such that the rank-up voltages of the respective main drive pulses become equal to each other, and the control unit determines the rotation state.

7. A stepping motor control circuit according to claim 4, wherein the control unit sets the second interval such that the smaller a duty ratio of a comb-teeth-shaped main drive pulse or the shorter a pulse width of a rectangular-wave main drive pulse, the longer the second interval becomes, and the control unit determines the rotation state.

8. A stepping motor control circuit according to claim 4, wherein the control unit changes the third interval corresponding to a change amount of the second interval such that the detection interval is not changed, and the control unit determines the rotation state.

9. A stepping motor control circuit according to claim 4, wherein the control unit stores an interval table which makes the respective main drive pulses and a length of the second interval correspond to each other and sets the second interval of a length corresponding to a present main drive pulse by looking up the interval table, and the control unit determines the rotation state.

10. A stepping motor control circuit according to claim 1, wherein the detection interval is divided into a first interval immediately after driving with the main drive pulse, a second interval which comes after the first interval, and a third interval which comes after the second interval, and in a usual load state, the first interval is an interval in which a normal-direction rotation state of the rotor is determined and an interval in which a first reverse-directional rotation state of the rotor is determined in a third quadrant of a space about the rotor, the second interval is an interval in which the first reverse-directional rotation state of the rotor is determined in the third quadrant, and the third interval is an interval in which a rotation state of the rotor after the first reverse-directional rotation is determined in the third quadrant, and
the control unit delays the start timing of the third interval such that the smaller the energy of the main drive pulse, the more the start timing of the third interval is delayed, and the control unit determines the rotation state.

11. A stepping motor control circuit according to claim 10, wherein the control unit changes the start timing of the third interval such that the difference among rank-up voltages of the respective main drive pulses falls within a predetermined range, and the control unit determines the rotation state.

12. A stepping motor control circuit according to claim 11, wherein the control unit changes the start timing of the third interval such that the rank-up voltages of the respective main drive pulses become equal to each other, and the control unit determines the rotation state.

13. A stepping motor control circuit according to claim 10, wherein the control unit delays the start timing of the third interval such that the smaller a duty ratio of a comb-teeth-shaped main drive pulse or the shorter a pulse width of a rectangular-wave main drive pulse, the more the start timing of the third interval is delayed, and determines the rotation state.

14. A stepping motor control circuit according to claim 10, wherein the control unit changes a length of the second interval corresponding to a change amount of the start timing of the third interval such that the detection interval is not changed, and the control unit determines the rotation state.

15. A stepping motor control circuit according to claim 10, wherein the control unit stores an interval table which makes the respective main drive pulses and the start timing of the third interval correspond to each other, sets the start timing of the third interval to timing corresponding to a present main drive pulse by looking up the interval table, and the control unit determines the rotation state.

16. A stepping motor control circuit according to claim 1, wherein the detection interval is divided into a first interval immediately after driving with the main drive pulse, a second interval which comes after the first interval, and a third interval which comes after the second interval, and in a usual load state, the first interval is an interval in which a normal-direction rotation state of the rotor is determined and an interval in which a first reverse-directional rotation state of the rotor is determined in a third quadrant of a space about the rotor, the second interval is an interval in which the first reverse-directional rotation state of the rotor is determined in the third quadrant, and the third interval is an interval in which a rotation state of the rotor after the first reverse-directional rotation is determined in the third quadrant, and
the control unit sets the start timings of the second interval and the third interval such that the smaller the energy of the main drive pulse, the more the start timings of the second interval and the third interval are delayed, and the control unit determines the rotation state.

17. A stepping motor control circuit according to claim 1, wherein the detection interval is divided into a first interval immediately after driving with the main drive pulse, a second interval which comes after the first interval, and a third interval which comes after the second interval, and in a usual load state, the first interval is an interval in which a normal-direction rotation state of the rotor is determined and an interval in which a first reverse-directional rotation state of the rotor is determined in a third quadrant of a space about the rotor, the second interval is an interval in which the first reverse-directional rotation state of the rotor is determined in the third quadrant, and the third interval is an interval in which a rotation state of the rotor after the first reverse-directional rotation is determined in the third quadrant,
the stepping motor control circuit includes a power source for driving the stepping motor, and
the control unit sets the start timing of the second interval such that the lower the voltage of the power source, the more the start timing of the second interval is delayed, and the control unit determines the rotation state.

18. A stepping motor control circuit according to claim 17, wherein the control unit sets the start timings of the second interval and the third interval such that the lower the voltage of the power source, the more the start timings of the second interval and the third interval are delayed, and the control unit determines the rotation state.

19. A stepping motor control circuit according to claim 17, wherein the control unit sets the start timing of the second interval such that the lower the voltage of the power source and the smaller the energy of the main drive pulse, the more the start timing of the second interval is delayed, and the control unit determines the rotation state.

20. A stepping motor control circuit according to claim 19, wherein the control unit sets the start timings of the second interval and the third interval such that the lower the voltage of the power source and the smaller the energy of the main drive pulse, the more the start timings of the second interval and the third interval are delayed, and the control unit determines the rotation state.

21. A stepping motor control circuit according to claim 16, wherein the control unit delays the start timing such that the difference among rank-up voltages of the respective main drive pulses falls within a predetermined range, and the control unit determines the rotation state.

22. A stepping motor control circuit according to claim 21, wherein the control unit delays the start timing such that the rank-up voltages of the respective main drive pulses become equal to each other, and the control unit determines the rotation state.

23. A stepping motor control circuit according to claim 16, wherein the control unit delays the start timing such that a length of the detection interval is not changed, and the control unit determines the rotation state.

24. An analogue electronic timepiece comprising:
a stepping motor which rotationally drives hands; and
a stepping motor control circuit which controls the stepping motor, wherein
the stepping motor control circuit called for in claim 1 is used as the stepping motor control circuit.
